(19) United States
(12) Patent Application Publication
(10) Pub. No.: US 2025/0280411 A1
(43) Pub. Date: Sep. 4, 2025

(54) METHOD AND APPARATUS FOR SUPPORTING MULTI-PANEL SIMULTANEOUS PUSCH TRANSMISSION

(71) Applicant: APPLE INC., Cupertino, CA (US)

(72) Inventors: Haitong Sun, Cupertino, CA (US); Hong He, San Jose, CA (US); Dawei Zhang, Saratoga, CA (US); Seyed Ali Akbar Fakoorian, San Diego, CA (US); Wei Zeng, San Diego, CA (US); Yushu Zhang, Beijing (CN); Chunxuan Ye, San Diego, CA (US); Oghenekome Oteri, San Diego, CA (US)

(21) Appl. No.: 18/857,983

(22) PCT Filed: Apr. 27, 2022
(86) PCT No.: PCT/CN2022/089460

§ 371 Date: Oct. 18, 2024

(51) Int. Cl. H04W 72/1268; H04W 72/0446; H04W 72/0453

(52) U.S. Cl. CPC H04W 72/1268; H04W 72/0446; H04W 72/0453

(57) ABSTRACT

An apparatus of a user equipment (UE), the apparatus comprising a processor, and a memory storing instructions that, when executed by the processor, configure the apparatus to: receive, from a base station, scheduling information for scheduling a first physical uplink shared channel (PUSCH) transmission and a second PUSCH transmission which are at least partially overlapped in time domain; and in response to the scheduling information, perform the first PUSCH transmission through a first antenna panel and the second PUSCH transmission through a second antenna panel by using mutually different frequency-domain resources.

### TECHNICAL FIELD

This application relates generally to wireless communication systems, including supporting multi-panel simultaneous Physical Uplink Shared Channel (PUSCH) transmission for frequency domain multiplexing (FDM).

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

LTE and NR have defined a Physical Uplink Shared Channel (PUSCH) as an uplink (UL) channel shared by all devices (also referred to as user equipment, UE) in a radio cell to transmit user data to the network. The scheduling for all UEs is under control of the LTE or NR base station (eNB or gNB). The base station uses an UL scheduling grant to inform the UE about resource assignments, modulation and coding scheme, precoding information, UL power control and the like. In addition to the user data, the PUSCH may also carry any control information or reference signal (RS) necessary to decode the data.

### SUMMARY

In one aspect, there is provided an apparatus of a user equipment (UE), the apparatus comprising: a processor; and a memory storing instructions that, when executed by the processor, configure the apparatus to: receive, from a base station, scheduling information for scheduling a first physical uplink shared channel (PUSCH) and a second PUSCH transmission which are at least partially overlapped in time domain; and in response to the scheduling information, perform the first PUSCH transmission through a first antenna panel and the second PUSCH transmission through a second antenna panel by using mutually different frequency-domain resources.

In another aspect, there is provided an apparatus of a base station, the apparatus comprising: a processor; and a memory storing instructions that, when executed by the processor, configure the apparatus to: send, to a user equipment (UE), scheduling information for scheduling a first physical uplink shared channel (PUSCH) transmission and a second PUSCH transmission which are partially overlapped in time domain; and receive the first PUSCH transmission and the second PUSCH transmission performed by the UE using mutually different frequency-domain resources in response to the scheduling information, wherein the first PUSCH transmission and the second PUSCH transmission are from a first antenna panel and a second antenna panel of the UE, respectively.

In still another aspect, there is provided a method, comprising: receiving, from a base station, scheduling information for scheduling a first physical uplink shared channel (PUSCH) transmission and a second PUSCH transmission which are at least partially overlapped in time domain; and in response to the scheduling information, performing the first PUSCH transmission through a first antenna panel and the second PUSCH transmission through a second antenna panel by using mutually different frequency-domain resources.

In yet still another aspect, there is provided a method, comprising: sending, to a user equipment (UE), scheduling information for scheduling a first physical uplink shared channel (PUSCH) transmission and a second PUSCH transmission which are partially overlapped in time domain; and receiving the first PUSCH transmission and the second PUSCH transmission performed by the UE using mutually different frequency-domain resources in response to the scheduling information, wherein the first PUSCH transmission and the second PUSCH transmission are from a first antenna panel and a second antenna panel of the UE, respectively.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a wireless communication system, according to some aspects of the present application.

FIG. 2 illustrates a system for performing signaling between a wireless device and a network device, according to some aspects of the present application.

FIG. 3 illustrates an example scenario of simultaneous multi-panel PUSCH transmission according to some aspects of the present application.

FIG. 4 is a flowchart diagram illustrating an example method for supporting the simultaneous multi-panel PUSCH transmission according to some aspects of the present application.

FIG. 5 is a flowchart diagram illustrating an example method for supporting the simultaneous multi-panel PUSCH transmission according to some aspects of the present application.

FIG. 6 illustrates a diagram of a frame structure in 5G NR.

FIG. 7 illustrates two FDM modes according to some aspects of the present application.

FIG. 8 illustrates a configuration of one-port phase tracking reference signal (PTRS) according to some aspects of the present application.

FIGS. 9a-9c illustrate example TB configurations according to some aspects of the present application.

### DETAILED DESCRIPTION

Various illustrative embodiments of the present application will be described hereinafter with reference to the drawings. For purpose of clarity and simplicity, not all features are described in the specification. Note that, however, many settings specific to the implementations can be made in practicing the embodiments of the present disclosure. In addition, it should be noted that in order to avoid obscuring the description, some of the figures illustrate only steps of a process and/or components of a device that are closely related to the technical solutions of the present application, while in some other figures, well-known process steps and/or device structures are shown for only better understanding of the present application.

For convenient explanation, various aspects of the present application will be described below in the context of the 5G NR. However, it should be noted that this is not a limitation on the scope of application of the present application, and one or more aspects of the present application can also be applied to wireless communication systems that have been commonly used, such as the 4G LTE/LTE-A, or various wireless communication systems to be developed in future. Equivalents to the architecture, entities, functions, processes and the like as described in the following description may be found in these communication systems.

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component. Examples of a UE may include a mobile device, a personal digital assistant (PDA), a tablet computer, a laptop computer, a personal computer, an Internet of Things (IoT) device, or a machine type communications (MTC) device, among other examples, which may be implemented in various objects such as appliances, or vehicles, meters, among other examples.

Moreover, various embodiments are described with regard to a “base station”. However, reference to a base station is merely provided for illustrative purposes. The term “base station” as used in the present application is an example of a control device in a wireless communication system, with its full breadth of ordinary meaning. For example, in addition to the gNB specified in the 5G NR, the “base station” may also be, for example, an eNB in the LTE communication system, a remote radio head, a wireless access point, a relay node, a drone control tower, or any communication device or an element thereof for performing a similar control function.

### System Overview

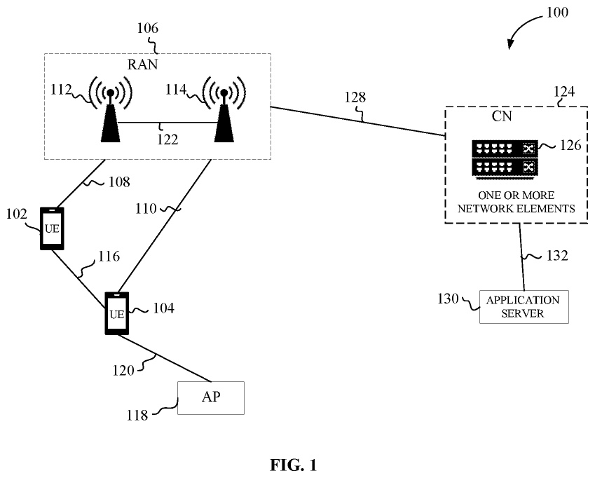

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112 and base station 114, that enable the connection 108 and connection 110.

In this example, the connection 108 and connection 110 are air interfaces to enable such communicative coupling, and may be consistent with RAT(s) used by the RAN 106, such as, for example, an LTE and/or NR.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may be configured to communicate with one another via interface 122. In embodiments where the wireless communication system 100 is an LTE system (e.g., when the CN 124 is an EPC), the interface 122 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 124 is a 5GC), the interface 122 may be an Xn interface. The Xn interface is defined between two or more base stations (e.g., two or more gNBs and the like) that connect to 5GC, between a base station 112 (e.g., a gNB) connecting to 5GC and an eNB, and/or between two eNBs connecting to 5GC (e.g., CN 124).

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an S1 interface 128. In embodiments, the S1 interface 128 may be split into two parts, an S1 user plane (S1-U) interface, which carries traffic data between the base station 112 or base station 114 and a serving gateway (S-GW), and the S1-MME interface, which is a signaling interface between the base station 112 or base station 114 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 124 (e.g., packet switched data services). The application server 130 can also be configured to support one or more communication services (e.g., VoIP sessions, group communication sessions, etc.) for the UE 102 and UE 104 via the CN 124. The application server 130 may communicate with the CN 124 through an IP communications interface 132.

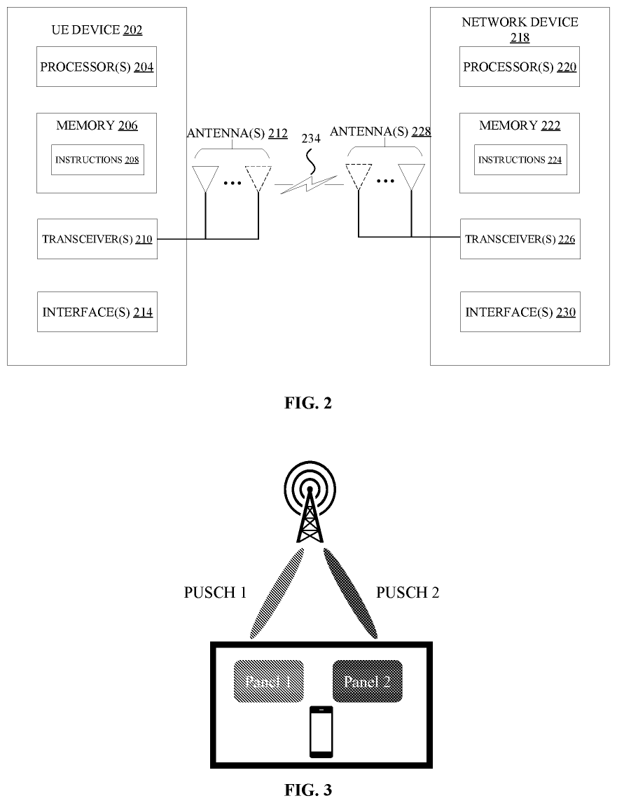

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs.

The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-Fi®, Bluetooth®, and the like).

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform MIMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

### Multi-Panel Simultaneous PUSCH Transmission

New cellular communication techniques are continually under development, to increase coverage, to better serve the range of demands and use cases, and for a variety of other reasons. One technique that is currently under development may include supporting multi-panel simultaneous transmission, for example, for purpose of higher throughput or reliability.

However, no explicit specification was agreed to support simultaneous multi-panel uplink (UL) transmission so far. Although several enhancements have been introduced to support multi-panel PUSCH operation, they are typically limited to time domain multiplexing (TDM) repetition, in which case multiple antenna panels may be switched to transmit UL data alternatively in the time domain, but there is not a period when they perform the PUSCH transmission at the same time.

FIG. 3 illustrates an example scenario of simultaneous multi-panel PUSCH transmission according to some aspects of the present application. In FIG. 3, two antenna panels (Panel 1 and Panel 2) of a UE (e.g., a cell phone) are shown for purpose of explanation, but the number of panels is not limited particularly. The UE may be provided with more than two antenna panels, such as three, four or even more antenna panels.

As used herein, “antenna panel” (also simply referred to as “panel”) is a collection of antennas, such as the antenna(s) 212 as depicted in FIG. 2. The antennas, each radiating electromagnetic waves according to its own amplitude parameter and phase parameter, are arranged into one or more antenna arrays in form of matrix. An antenna array can be composed of an entire row, an entire column, multiple rows, and multiple columns of antennas. Each antenna array actually constitutes a Transceiver Unit (TXRU) that can be configured independently. By configuring the amplitude parameters and/or phase parameters for the antennas that make up the TXRU to adjust the TXRU antenna pattern, the electromagnetic wave radiations emitted by all of the antennas form a narrow beam pointing to a specific spatial direction, that is, beamforming is implemented. Physically, one antenna panel may include one or more antenna array, and if the antenna arrays operate in the same pattern, they can be seen as a single larger array. That is, in some cases, the panel as used herein may be equivalent to so-called antenna array.

As illustrated in FIG. 3, the UE may activate and utilize its Panel 1 and Panel 2 to perform PUSCH transmissions (e.g., PUSCH 1 and PUSCH 2 as shown) simultaneously. It will be appreciated that PUSCH 1 and PUSCH 2 are just used to identify the PUSCH transmission from Panel 1 and the PUSCH transmission from Panel 2, respectively, but it does not mean they must be distinguished from each other in essence. PUSCH 1 and PUSCH 2 may be transmitted to the same Transmit Receive Point (TRP) or different TRPs. PUSCH 1 and PUSCH 2 may serve the same Hybrid Automatic Repeat reQuest (HARQ) process or different HARQ processes. PUSCH 1 and PUSCH 2 may be scheduled in the same UL grant or different UL grants, i.e., single downlink control information (DCI) based or multi-DCI based.

According to some aspects of the present application, the simultaneous PUSCH transmissions from multiple panels, such as PUSCH 1 and PUSCH 2 in FIG. 3, are supported be means of frequency domain multiplexing (FDM). In other words, the multiple panels perform their own PUSCH operations by using different frequency-domain resources.

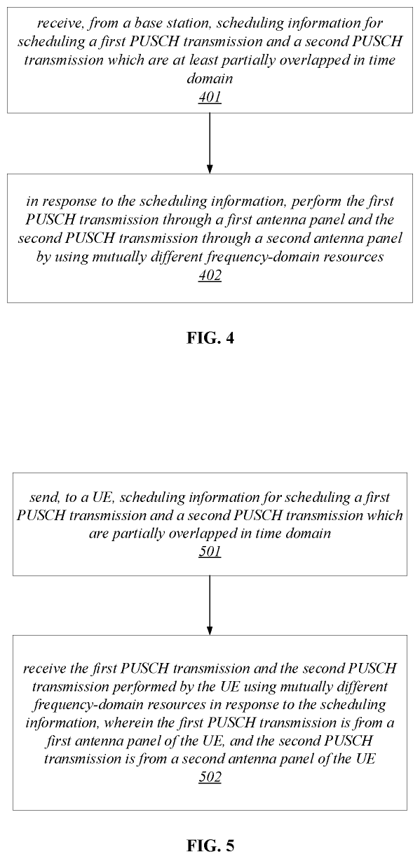

FIG. 4 is a flowchart diagram illustrating an example method for supporting the simultaneous multi-panel PUSCH transmission according to some aspects of the present application. The method may be carried out at a UE.

At 401, the UE receives, from a base station (e.g., a gNB), scheduling information for scheduling a first PUSCH transmission and a second PUSCH transmission, where the first and second PUSCH transmission are at least partially overlapped in time domain, that is, the first PUSCH transmission and the second PUSCH transmission are not necessarily aligned in the time domain, but may result in at least one time-domain scheduling unit during which they are transmitted simultaneously.

At 402, in response to the received scheduling information, the UE performs the first PUSCH transmission through a first antenna panel of the UE and performs the second PUSCH transmission through a second antenna panel of the UE. The scheduling information may allocate or activate mutually different frequency-domain resources for the first and second PUSCH transmissions, whereby the PUSCH transmissions from the first and second panels may be performed simultaneously by means of FDM.

FIG. 5 is a flowchart diagram illustrating an example method for supporting the simultaneous multi-panel PUSCH transmission according to some aspects of the present application. The method may be carried out at a base station, such as a gNB.

At 501, the base station may send, to a UE, scheduling information for scheduling a first PUSCH transmission and a second PUSCH transmission, where the first and second PUSCH transmission are at least partially overlapped in time domain, that is, both of them are scheduled in at least one time-domain scheduling unit. The scheduling information may allocate or activate mutually different frequency-domain resources for FDM of the first and second PUSCH transmissions.

At 502, the base station may receive the first PUSCH transmission and the second PUSCH transmission from the UE over the mutually different frequency-domain resources. The first PUSCH transmission may be from a first antenna panel of the UE, and the second PUSCH transmission may be from a second antenna panel of the UE. Subsequently, not shown in FIG. 5, the base station may decode the first PUSCH transmission and the second PUSCH transmission separately or jointly, so as to acquire user data carried thereon.

Hereinafter, some further aspects of the present application will be described for the better understanding thereof.

### Frequency Domain Resource Assignment (FDRA)

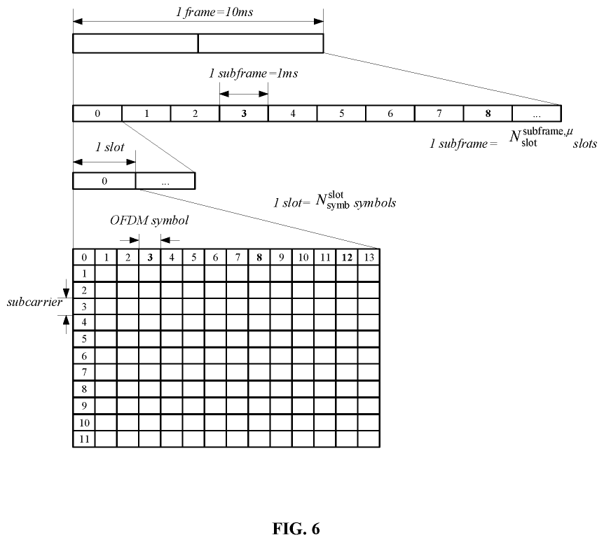

In 5G NR, both of downlink and uplink transmissions are organized into frames. FIG. 6 shows a diagram of a frame structure in 5G NR. As a fixed frame compatible with LTE/LTE-A, the frame in NR also has a length of 10 ms and includes 10 subframes of equal size, each of which has a length of 1 ms. Unlike LTE/LTE-A, the frame structure in NR has a flexible structure that depends on supported transmission numerologies. As shown in FIG. 6, each subframe has a configurable number Nₛₗₒₜ^{subframe, μ} of time slots, such as 1, 2, 4, 8 or 16. Each slot also has a configurable number N_{symb}^{slot} of OFDM symbols. For a normal cyclic prefix, each slot includes 14 consecutive OFDM symbols, and for an extended cyclic prefix, each slot includes 12 consecutive OFDM symbols. In the frequency domain dimension, each time slot includes several resource blocks (RBs), and each resource block may include 12 consecutive subcarriers in the frequency domain. Thus, a resource grid can be used to represent resource elements (RE) in a time slot.

The resource blocks available for uplink transmission can be divided into data sections and control sections. The resource elements in the control sections can be allocated to the UE for transmission of control information. The data sections may include all resource elements that are not included in the control sections. The UE may also be allocated with resource elements in the data sections for transmitting data to the base station.

When having data to be transmitted, the UE can send a scheduling request (SR) and/or a buffer status report (BSR) to the base station to request time-frequency resources for transmitting the user data. In a resource scheduling based on dynamic grant, the base station can use DCI containing resource assignment information to dynamically schedule the PUSCH. In a resource scheduling based on configured grant, the base station can pre-configure available time-frequency resources for the UE through RRC layer signaling, so that UE can directly use the pre-configured time-frequency resources for PUSCH transmission without requesting the base station to send an UL grant each time.

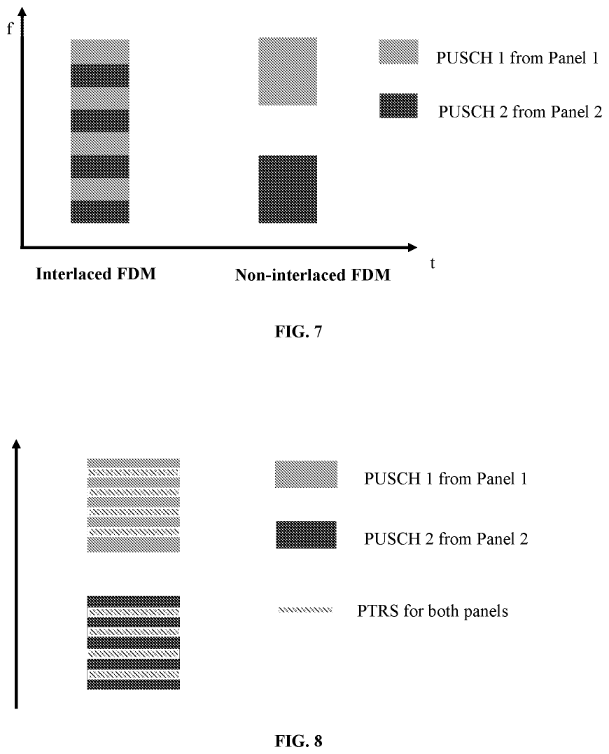

According to one aspect of the present application, the PUSCH transmissions from different panels may be scheduled in mutually different sets of frequency-domain resources. Typically, two scheduling modes may be adopted, namely, an interlaced FDM and a non-interlaced FDM, which are illustrated in FIG. 7.

With reference to the example of two panels as shown in FIG. 6, in the interlaced FDM, the frequency-domain resources for PUSCH 1 and the frequency-domain resources for PUSCH 2 may be interlaced based on an interlace unit. The interlace unit may be a RE, a physical resource block (PRB), or multiple PRBs. For example, in case of the interlace unit of one PRB, even PRBs may be allocated to PUSCH 1, while odd PRBs may be allocated to PUSCH 2, and vice versa.

To schedule such interlaced FDM, a single FDRA is indicated in the scheduling information for both of PUSCH 1 and PUSCH 2. For example, the FDRA may be implemented by “Frequency domain resource assignment” field in DCI for scheduling PUSCH, such as DCI format 0_0 or 0_1 or 0_2. The frequency-domain resources scheduled by the FDRA is split between PUSCH 1 and PUSCH 2, and interlaced based on the interlace unit. Examples of the interlace unit includes one or more REs, one or more PRBs, or the like. The interlace unit may be hardcoded in the protocol specification, or may be configurable by RRC layer signaling, such as ConfiguredGrantConfig or PUSCH-Config information element (IE), or by Medium Access Control (MAC) layer signaling, such as MAC control element (CE), or by physical layer DCI, such as the DCI including the FDRA. In this manner, the resources indicated by the FDRA actually include two sets of frequency-domain resources, each for one PUSCH (further for one panel).

In the non-interlaced FDM, the frequency-domain resources for PUSCH 1 and the frequency-domain resources for PUSCH 2 may be separated by a number X>=0 of frequency-domain resources (e.g., REs or PRBs), as shown in FIG. 7. Although FIG. 7 depicts the resources for each of PUSCH 1 and PUSCH 2 as an unbroken block, they may or may not be inconsecutive. Moreover, the resources for PUSCH 1 and the resources for PUSCH 2 may be adjacent in the frequency domain (i.e., X=0) or may not be adjacent in the frequency domain (i.e., X>0).

To support the non-interlaced FDM, in one example, a single FDRA is indicated in the scheduling information for one of PUSCH 1 and PUSCH 2 (e.g., for PUSCH 1), and the frequency-domain resources for the other (e.g., for PUSCH 2) may be determined by the FDRA and a frequency offset which specifies an offset of the resources for PUSCH 2 relative to the resources for PUSCH 1, both of which may span across the same number of RBs in the frequency domain. The frequency offset may be defined from the end of the frequency-domain resources for PUSCH 1, or from the start of the frequency-domain resources for PUSCH 1. Examples of the frequency offset may include zero or more REs, zero or more PRBs, or the like. The frequency offset may be configurable by RRC layer signaling, by MAC CE, or by DCI, such as the DCI including the FDRA.

In another example, independent FDRAs are indicated in the scheduling information for PUSCH 1 and PUSCH 2. For example, two “Frequency domain resource assignment” fields can be introduced in DCI, each for one PUSCH (further for one panel). When receiving such DCI, the UE may determine respective FDRA for each of PUSCH 1 and PUSCH 2 from the two “Frequency domain resource assignment” fields. In this example, PUSCH 1 and PUSCH 2 may be allocated with different RBs.

Furthermore, according to an aspect of the present application, the same resource allocation type is applicable to the PUSCH transmissions simultaneously transmitted by all of the panels. The resource allocation type specifies how RBs are allocated to the UE. For the configured grant, the resource allocation type is configured in RRC parameter resourceAllocation of ConfiguredGrantConfig, for example, as follows:

| ConfiguredGrantConfig ::= | SEQUENCE { | |
|---|---|---|
| frequencyHopping | ENUMERATED {mode1, mode2} | OPTIONAL, -- Need S, |

| | |
|---|---|
| cg-DMRS-Configuration | DMRS-UplinkConfig, |
| mcs-Table | ENUMERATED {qam256, spare1} |

OPTIONAL, -- Need S

| | | |
|---|---|---|
| mcs-TableTransformPrecoder | ENUMERATED {qam256, spare1} | OPTIONAL, -- Need S |

| | |
|---|---|
| uci-OnPUSCH | SetupRelease { CG-UCI-OnPUSCH }, |
| resourceAllocation | ENUMERATED { resourceAllocationType0, |

resourceAllocationType1, dynamicSwitch },

While for the dynamic grant, the resource allocation type is configured in RRC parameter resourceAllocation of PUSCH-Config, for example, as follows:

| PUSCH-Config ::= | SEQUENCE { | |
|---|---|---|
| dataScramblingIdentityPUSCH | INTEGER (0..1023) | OPTIONAL, -- Need M |
| txConfig | ENUMERATED {codebook, nonCodebook} | OPTIONAL, -- Need S |
| dmrs-UplinkForPUSCH-MappingTypeA | SetupRelease { DMRS-UplinkConfig } | OPTIONAL, -- Need M |
| dmrs-UplinkForPUSCH-MappingTypeB | SetupRelease { DMRS-UplinkConfig } | OPTIONAL, -- Need M |
| pusch-PowerControl | PUSCH-PowerControl | OPTIONAL, -- Need M |
| frequencyHopping | ENUMERATED {mode1, mode2} | OPTIONAL, -- Need S |

| | |
|---|---|
| frequencyHoppingOffsetLists | SEQUENCE (SIZE (1..4)) OF INTEGER (1.. |
| maxNrofPhysicalResourceBlocks-1) | OPTIONAL, -- Need M |
| resourceAllocation | ENUMERATED { resourceAllocationType0, |

resourceAllocationType1, dynamicSwitch},

There are generally two resource allocation types, including resource allocation type 0 and resource allocation type 1. PUSCH 1 and PUSCH 2 may be configured with the RRC parameter resourceAllocation set to “resourceAllocationType0” so that their frequency-domain resource assignments follow the resource allocation type 0, or with the RRC parameter resourceAllocation set to “resourceAllocationType1” so that their frequency-domain resource assignments follow the resource allocation type 1. When the RRC parameter resource Allocation is configured as “dynamicSwitch”, both of PUSCH 1 and PUSCH 2 are to be indicated dynamically, with always the same resource allocation type, either the resource allocation type 0 or the resource allocation type 1.

### Time Domain Resource Assignment (TDRA)

As used herein, “simultaneous” PUSCH transmission means there is a time period in which two or more panels are performing the PUSCH operation. In the time domain, the PUSCH transmission from one panel may or may not be completely aligned with the PUSCH transmission from another panel, but they are at least partially overlapped.

According to the present application, as a result of supporting the simultaneous multi-panel PUSCH transmission, the base station can schedule the PUSCH transmissions in an overlapped manner. Hereinafter, TDRA will be described by also referring to the example case of two panels as illustrated in FIG. 3.

In one aspect, a single TDRA is indicated in the scheduling information for both of PUSCH 1 and PUSCH 2, which are assumed to have the same time-domain resources. For example, the TDRA may be implemented by “Time domain resource assignment” field in DCI for scheduling PUSCH, such as DCI format 0_0 or 0_1 or 0_2. Examples of the time-domain scheduling unit include one or more slots, or even several OFDM symbols in a slot, called a mini slot. When receiving such DCI, the UE may apply the time-domain resources to the PUSCH transmissions to be transmitted from Panel 1 and Panel 2. This scheduling manner is applicable especially when the PUSCH transmissions serve for the same HARQ process.

In another aspect, independent TDRAs are indicated in the scheduling information for PUSCH 1 and PUSCH 2. For example, two “Time domain resource assignment” fields can be introduced in DCI, each for one PUSCH (further for one panel). When receiving such DCI, the UE may determine respective TDRA for each of PUSCH 1 and PUSCH 2 from the two “Time domain resource assignment” fields. In this example, PUSCH 1 and PUSCH 2 may be allocated independently, for example, with different number of slots, which may be applicable when the PUSCH transmissions serve for different HARQ processes.

In the case of multiple “Time domain resource assignment” fields, the TDRA indications for different PUSCH transmissions may refer to the same TDRA table. The TDRA table is a table configured by RRC signaling, such as pusch-TimeDomainAllocationList or its variant, including pusch-TimeDomainAllocationListDCI-0-1, pusch-TimeDomainAllocationListDCI-0-2, or pusch-TimeDomainAllocationListForMultiPUSCH as defined in 3GPP Release 16, or pusch-TimeDomainResourceAllocationListForMultiPUSCH as defined in 3GPP Release 17. The TDRA table has a list of entries, each of which maps a “TDRA” index to corresponding time domain resource allocation. Each entry of the TDRA table can be configured with the same time domain resource allocation for both panels, or, different time domain resource allocation for each panel respectively.

Alternatively, the TDRA indications for different PUSCH transmissions may refer to different TDRA tables which are separately configured by the RRC signaling. As a result, PUSCH 1 to be transmitted from Panel 1 and PUSCH 2 to be transmitted from Panel 2 may be scheduled according to different time domain resource allocation types.

### Precoding Indication

Precoding techniques can be utilized to improve the system performance. Generally, there are digital precoding on baseband signals, analog precoding on radio frequency (RF) signals, or a combination of them, such as hybrid precoding.

Based on usage of codebook in the digital precoding, NR supports two PUSCH transmission schemes, namely codebook based transmission or non-codebook based transmission, and up to 4 layers. The UE is configured with the codebook based transmission when the higher layer parameter txConfig is set to “Codebook”, and the UE is configured with non-codebook based transmission when the higher layer parameter txConfig is set to “nonCodebook”.

For the codebook based UL transmission, the UE transmits Sounding Reference Signal (SRS) resources in a SRS resources set with multiple ports to the base station, and the base station performs uplink channel detection, and determines a precoder (precoding matrix) to be used from a codebook and the number of layers. The base station schedules the PUSCH transmission by indicating SRS resource indicator (SRI) which identifies the SRS resource corresponding to the selected precoding matrix, a transmit precoding matrix indicator (TPMI) which identifies the selected precoding matrix, and a rank indication (RI) which indicates the number of layers.

For the non-codebook based transmission, the UE detects downlink reference signals, such as channel state information RS (CSI-RS), and calculates uplink candidate SRS precoders in accordance with channel reciprocity of the uplink and downlink channels. The UE precodes multiple SRS resources with the candidate SRS precoders and transmit the precoded SRS resources, each with a single port, to the base station. The base station receives the SRS resources, and selects one or more appropriate SRS resources depending on the uplink channel condition. The base station schedules the PUSCH transmission by indicating the one or more selected SRS resources/ports with SRI, and the number of layers is indicated by the number of selected SRS resources.

The analog precoding, which is also referred to as analog beamforming or beamforming, is used to form a directional beam by applying phase adjustments to RF signals at antennas in an antenna array. The UE is configured with a set of beams, and an optimal pair of transmit beam and receive beam are determined by a process of beam training. For example, the UL beam training may include: 1) beam scanning, the UE transmits SRS resources in a SRS resource set to the base station; 2) beam measurement, the base station measures the received SRS and determines a SRS resource that has the best beam gain; and 3) beam indication, the base station indicates the selected SRS resource to the UE, so that the UE can use the beam corresponding to this SRS resource for UL transmission. The beam indication may be implemented by SRI which identifies the selected SRS resource. Alternatively, unified transmission configuration indication (TCI) state including information identifying the uplink spatial filter may be used for the UL beam indication.

According to one aspect of the present application, various precoding information including SRI, TPMI, RI and unified TCI state may be indicated to the UE for supporting the simultaneous multi-panel PUSCH transmission, for example, along with the FDRA and TDRA. DCI, such as format 0_1 or 0_2, may be used to carry one or more of a “SRS resource indicator” field for indicating SRI which may be used for the digital precoding and/or the analog precoding; a “Precoding information and number of layers” field for indicating TPMI and RI which may be used in the digital precoding for the codebook based PUSCH transmission; or a “Transmission configuration indication” field for indicating TCI state which may be used for the analog precoding.

In one example, independent precoding information may be indicated for different PUSCH transmissions (further for different panels). Also with reference to the example of two panels of FIG. 3, two “SRS resource indicator” fields may be introduced in DCI, each for one panel, and the UE may determine respective uplink transmit precoding matrix and/or uplink beam for each of PUSCH 1 and PUSCH 2; two “Precoding information and number of layers” fields may be introduced in DCI, each for one panel, and the UE may determine respective uplink transmit precoding matrix for each of PUSCH 1 and PUSCH 2; and/or two “Transmission configuration indication” fields may be introduced in DCI, each for one panel, and the UE may determine respective uplink beam for each of PUSCH 1 and PUSCH 2.

In another example, a single piece of precoding information may be indicated for the simultaneous PUSCH transmissions which are assumed to have the same SRI/TPMI/RI/unified TCI state.

According to one aspect of the present application, the same number of layers (ranks) is scheduled for all PUSCH transmissions from the multiple panels, for example, 2 layers per panel. The same antenna port configuration is assumed for all PUSCH transmissions from the multiple panels.

In an example case of maximum two layers for PUSCH transmission per panel, only one bit of “PTRS-DMRS association” field may be introduced in DCI to indicate an association between phase tracking reference signal (PTRS) and demodulation reference signal (DMRS). For example, if the field is set to “0”, the PTRS is mapped to the first DMRS port, and if the field is set to “0”, the PTRS is mapped to the second DMRS port.

In one aspect, 1 port PTRS may be shared among the PUSCH transmissions from different panels. The PTRS typically is distributed at a low density in the frequency domain and at a high density in the time domain. FIG. 8 illustrates the application of the PTRS in the time-frequency resources (for example, the non-interlaced mode of FIG. 3 for illustration). The PTRS of one port is used for phase noise estimation of both PUSCH 1 from Panel 1 and PUSCH 2 from Panel 2.

### Transport Block (TB) Configuration

For the PUSCH transmission, user data from the Medium Access Control (MAC) layer will be processed as a TB, which needs to go through a series of uplink physical layer processing in order to be mapped to the transmission channel in the physical layer. Uplink physical layer processing generally includes:
cyclic redundancy check (CRC) addition to the transport block;
code block segmentation and code block CRC addition;
channel coding;
physical layer HARQ processing;
rate matching;
scrambling;
modulation;
layer mapping, transform precoding and precoding;
mapping to allocated resources and antenna ports, and so on.

Through various signal processing functions of the physical layer, the bit stream as user data is encoded and modulated into OFDM symbols, and is transmitted to the base station by respective antenna array/panel using allocated time-frequency resources. The base station receiving the signal receives and decodes the user data through an inverse process of the above-mentioned signal processing.

As mentioned above, the PUSCH transmissions from different panels may be used in a flexible manner. According to one aspect of the present application, one or more of the following use cases can be supported.

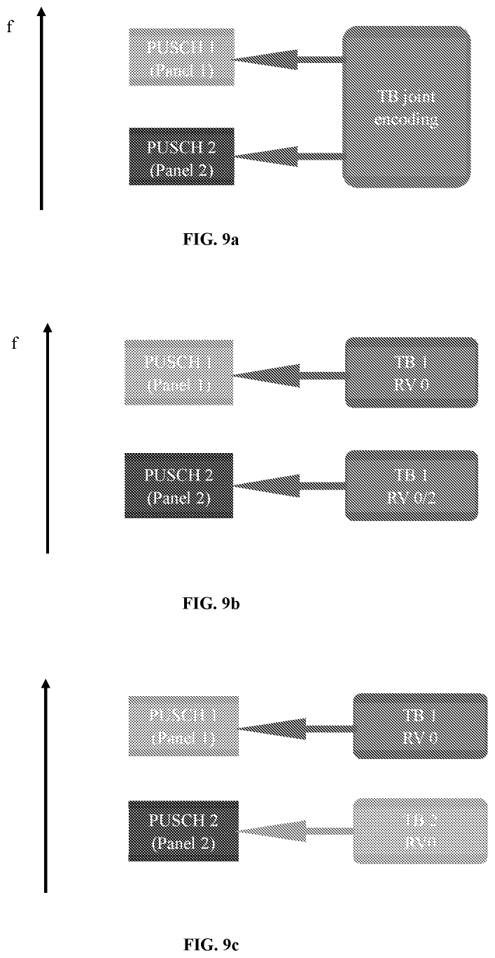

Case 1: a TB is jointly encoded and transmitted from all panels. As exemplarily shown in FIG. 9a, for a TB to be transmitted, available number of REs is the union of the REs for PUSCH 1 from Panel 1 and PUSCH 2 from Panel 2, as indicated in the FDRA and TDRA. The base station may determine a modulation and coding scheme (MCS) based on the total REs for PUSCH 1 and PUSCH 2 and the size of the TB for which the PUSCH transmission is requested, and may indicate the determined MCS to the UE, for example, via a single “Modulation and coding scheme” field in DCI.

In Case 1, the PUSCH transmissions from the multiple panels are used for one HARQ process, and a single “New data indicator (NDI)” field is needed in DCI for indicating the PUSCH transmissions are retransmission or initial transmission for the TB.

Case 2: a TB is encoded separately and transmitted from all panels in repetition. As exemplarily shown in FIG. 9b, for a TB to be transmitted, available number of REs is the REs for each of PUSCH 1 from Panel 1 and PUSCH 2 from Panel 2. The base station may determine a MCS based on the total REs for either PUSCH 1 or PUSCH 2 and the size of the TB, and may indicate the determined MCS to the UE, for example, via a single “Modulation and coding scheme” field in DCI. Also, the UE may use the PUSCH transmissions for one HARQ process, with a single “New data indicator” field in DCI.

For PUSCH 1 and PUSCH 2, the same or different redundancy version (RV) may be applied to the respective TB in accordance with a RV sequence. The RV determines the rate matching of the encoded TB, and may also been indicated in DCI, i.e., in “Redundancy version” field. As shown in FIG. 9b, RV 0 is applied to TB 1 to be transmitted by PUSCH 1, and the same RV0 or a different RV2 is applied to TB 1 to be transmitted by PUSCH 2.

Case 3: different TBs are encoded and transmitted from different panels. As exemplarily shown in FIG. 9c, TB 1 is to be transmitted by PUSCH 1 from Panel 1, and TB 2 is to be transmitted by PUSCH 2 from Panel 2. Thus, available number of REs for TB 1 is the REs for PUSCH 1, and available number of REs for TB 2 is the REs for PUSCH 2. For PUSCH 1 and PUSCH 2, different or the same redundancy version may be applied to the respective TB in accordance with a RV sequence.

The base station may determine MCS for each of PUSCH 1 and PUSCH 2, based on available REs and the size of the respective TB. If the same MCS is used, then the base station may indicate the common MCS to the UE, for example, via a single “Modulation and coding scheme” field in DCI. Alternatively, independent “Modulation and coding scheme” fields can be introduced in DCI, each for one PUSCH (further for one panel).

In Case 3, the UE may use the PUSCH transmissions from the multiple panels for transmitting different TBs in one HARQ process, or may use them for transmitting different TBs in different HARQ processes. Moreover, a common “New data indicator” field or independent “New data indicator” fields may be indicated in DCI.

Although three example cases are described above, the simultaneous multi-panel PUSCH transmissions may be used for any other possible purpose, which shall be fallen within the scope of the present application.

### Uplink Power Control

According to one aspect of the present application, various uplink power control strategies may be used for the simultaneous multi-panel PUSCH transmissions.

In one example, the base station may schedule the PUSCH transmissions from multiple panels such that the same power spectral density (PSD) is ensured. For Open Loop Power Control (OLPC), when a plurality of pathloss reference signals (such as SSB), each for one panel, are configured, pathloss from only one reference signal is used by the UE. For example, the UE may compensate for the largest pathloss out of “quality first” consideration, or may compensate for the smallest pathloss out of “energy saving first”. For Close Loop Power Control (CLPC), the base station may perform transmit power control (TPC) for the PUSCH transmissions, for example, via “TPC command for scheduled PUSCH” field in DCI.

The base station may send a single TPC command for all PUSCH transmissions to the UE, and the UE adjusts respective transmit power from each of its panels. Alternatively, the base station may send independent TPC commands to the UE, each for one PUSCH transmission (further for one panel). In this case, multiple “TPC command for scheduled PUSCH” fields can be introduced in DCI. When receiving the TPC commands, the UE makes only one TPC decision, for example, either “or of down” or “or of up”.

In another example, each of the PUSCH transmissions from multiple panels can have its own different transmit power. Specifically, the base station may send independent TPC commands for the PUSCH transmissions to the UE, for example, via multiple “TPC command for scheduled PUSCH” fields in DCI. The UE sets respective transmit power for each of the PUSCH transmissions based on these TPC commands.

The simultaneous PUSCH transmission from multiple panels may face requirements on maximum permissible exposure. For example, Federal Communication Commission has raised limitations on Equivalent Isotropically Radiated Power (EIRP), for example, 1 mW/cm². Another consideration is related to energy saving, especially the UE is an energy limited device powered by a battery. If two or more panels are transmitting, the limitations are posed on the total of their transmit power. Therefore, there might be a need for scaling the transmit power of the PUSCH transmissions under a total threshold.

In one example, the transmit power of each of the PUSCH transmissions is scaled by the same factor, for example, −3 dB or the like, such that the total transmit power does not exceed the associated requirements.

In another example, the scaling of the transmit power of the PUSCH transmissions may be based on priority or ranking. The PUSCH with the low priority is scaled the first. For example, with reference to the case of two panels of FIG. 3, assuming PUSCH 1 has a higher priority than PUSCH 2, the UE may apply a less scaling to the transmit power of PUSCH 1 or no scaling at all, while the UE may apply a more scaling to the transmit power of PUSCH 2. This may ensure the quality of service of PUSCH 1. The priority may be based on the order of the panels. The panels may correspond to a logic ID, for example, a SRS resource ID, and the base station may control the scaling of PUSCH transmissions from the panels via the logic IDs.

The correspondence between PUSCH and physical panel might be agnostic to the base station. The base station schedules two sets of resources for two PUSCH transmissions, but may not decide which panel transmits a particular PUSCH. The decision may depend on implementations at the UE, especially when the UE is equipped with more than two panels. However, the base station may specify a desired panel selection, for example, via the logic ID of a panel. That is, there is a possibility that the base station may be able to control a particular panel of the UE to perform a PUSCH operation after the UE has reported its panel configuration as UE capability.

Embodiments contemplated herein include an apparatus comprising means to perform one or more elements of the method as shown in FIG. 4. This apparatus may be, for example, an apparatus of a UE (such as a wireless device 202 that is a UE, as described herein).

Embodiments contemplated herein include one or more non-transitory computer-readable media comprising instructions to cause an electronic device, upon execution of the instructions by one or more processors of the electronic device, to perform one or more elements of the method as shown in FIG. 4. This non-transitory computer-readable media may be, for example, a memory of a UE (such as a memory 206 of a wireless device 202 that is a UE, as described herein).

Embodiments contemplated herein include an apparatus comprising logic, modules, or circuitry to perform one or more elements of the method as shown in FIG. 4. This apparatus may be, for example, an apparatus of a UE (such as a wireless device 202 that is a UE, as described herein).

Embodiments contemplated herein include an apparatus comprising: one or more processors and one or more computer-readable media comprising instructions that, when executed by the one or more processors, cause the one or more processors to perform one or more elements of the method as shown in FIG. 4. This apparatus may be, for example, an apparatus of a UE (such as a wireless device 202 that is a UE, as described herein).

Embodiments contemplated herein include a signal as described in or related to one or more elements of the method as shown in FIG. 4.

Embodiments contemplated herein include a computer program or computer program product comprising instructions, wherein execution of the program by a processor is to cause the processor to carry out one or more elements of the method as shown in FIG. 4. The processor may be a processor of a UE (such as a processor(s) 204 of a wireless device 202 that is a UE, as described herein). These instructions may be, for example, located in the processor and/or on a memory of the UE (such as a memory 206 of a wireless device 202 that is a UE, as described herein).

Embodiments contemplated herein include an apparatus comprising means to perform one or more elements of the method as shown in FIG. 5. This apparatus may be, for example, an apparatus of a base station (such as a network device 218 that is a base station, as described herein).

Embodiments contemplated herein include one or more non-transitory computer-readable media comprising instructions to cause an electronic device, upon execution of the instructions by one or more processors of the electronic device, to perform one or more elements of the method as shown in FIG. 5. This non-transitory computer-readable media may be, for example, a memory of a base station (such as a memory 222 of a network device 218 that is a base station, as described herein).

Embodiments contemplated herein include an apparatus comprising logic, modules, or circuitry to perform one or more elements of the method as shown in FIG. 5. This apparatus may be, for example, an apparatus of a base station (such as a network device 218 that is a base station, as described herein).

Embodiments contemplated herein include an apparatus comprising: one or more processors and one or more computer-readable media comprising instructions that, when executed by the one or more processors, cause the one or more processors to perform one or more elements of the method as shown in FIG. 5. This apparatus may be, for example, an apparatus of a base station (such as a network device 218 that is a base station, as described herein).

Embodiments contemplated herein include a signal as described in or related to one or more elements of the method as shown in FIG. 5.

Embodiments contemplated herein include a computer program or computer program product comprising instructions, wherein execution of the program by a processing element is to cause the processing element to carry out one or more elements of the method as shown in FIG. 5. The processor may be a processor of a base station (such as a processor(s) 220 of a network device 218 that is a base station, as described herein). These instructions may be, for example, located in the processor and/or on a memory of the UE (such as a memory 222 of a network device 218 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

### EXAMPLE SECTION

The following examples pertain to further embodiments.

Example 1 may include an apparatus of a user equipment (UE), the apparatus comprising: a processor; and a memory storing instructions that, when executed by the processor, configure the apparatus to: receive, from a base station, scheduling information for scheduling a first physical uplink shared channel (PUSCH) transmission and a second PUSCH transmission which are at least partially overlapped in time domain; and in response to the scheduling information, perform the first PUSCH transmission through a first antenna panel and the second PUSCH transmission through a second antenna panel by using mutually different frequency-domain resources.

Example 2 may include the apparatus of Example 1, wherein the frequency-domain resources for the first PUSCH transmission are interlaced with the frequency-domain resources for the second PUSCH transmission.

Example 3 may include the apparatus of Example 2, wherein the scheduling information includes a Frequency Domain Resource Assignment (FDRA), and frequency-domain resources indicated by the FDRA are split and interlaced based on an interlace unit for the first and second PUSCH transmissions, and wherein the interlace unit is one of a resource element (RE), a physical resource block (PRB) or multiple PRBs.

Example 4 may include the apparatus of Example 1, wherein the frequency-domain resources for the first PUSCH transmission are separated from the frequency-domain resources for the second PUSCH transmission.

Example 5 may include the apparatus of Example 4, wherein the scheduling information includes one of the following: a Frequency Domain Resource Assignment (FDRA) for the first PUSCH transmission, wherein the frequency-domain resources for the second PUSCH transmission are determined by a frequency offset from the frequency-domain resources for the first PUSCH transmission, the frequency offset including 0 or more resource elements (REs) or physical resource blocks (PRBs), or respective FDRAs for the first and second PUSCH transmissions.

Example 6 may include the apparatus of Example 1, wherein the same resource allocation type is configured for the first and second PUSCH transmissions.

Example 7 may include the apparatus of Example 1, wherein the scheduling information includes a Time Domain Resource Assignment (TDRA) for both of the first and second PUSCH transmissions.

Example 8 may include the apparatus of Example 1, wherein the scheduling information includes respective Time Domain Resource Assignments (TDRAs) for the first and second PUSCH transmissions.

Example 9 may include the apparatus of Example 8, wherein the TDRAs refer to the same TDRA table, or wherein the TDRAs refer to different TDRA tables.

Example 10 may include the apparatus of Example 1, wherein the scheduling information includes one of the following: precoding information common to the first and second PUSCH transmissions, or respective precoding information for the first and second PUSCH transmission, wherein the precoding information includes at least one of sounding reference signal (SRS) resource indicator (SRI), transmission configuration indication (TCI) state, and transmit precoding matrix indicator (TPMI).

Example 11 may include the apparatus of Example 1, wherein the first PUSCH transmission and the second PUSCH transmission have the same number of layers; and/or

wherein the first PUSCH transmission and the second PUSCH transmission have the same antenna port configuration.

Example 12 may include the apparatus of Example 11, wherein the scheduling information includes PTRS-DMRS association information common to the first and second PUSCH transmissions, and/or wherein the first and second PUSCH transmissions share the same one-port PTRS.

Example 12 may include the apparatus of Example 1, wherein at least one of the following is supported: a transport block (TB) is jointly encoded for and transmitted by the first and second PUSCH transmissions; or a TB is transmitted by the first and second PUSCH transmissions in repetition; or different TBs are transmitted by the first and second PUSCH transmission.

Example 14 may include the apparatus of Example 1, wherein the scheduling information includes Modulation and coding scheme (MSC) and/or new data indicator (NDI) and/or Redundancy Version (RV) common to the first and second PUSCH transmissions; or

wherein the scheduling information includes respective MSCs and/or NDIs and/or RVs for the first and second PUSCH transmissions.

Example 15 may include the apparatus of Example 1, wherein the scheduling information includes uplink power control information such that the same power spectral density (PSD) is ensured for both of the first and second PUSCH transmissions, or the first and second PUSCH transmissions have their own different transmit power.

Example 16 may include the apparatus of Example 15, wherein the transmit power of each of the first and second PUSCH transmissions is scaled by the same factor or based on priority.

Example 17 may include an apparatus of a base station, the apparatus comprising: a processor; and a memory storing instructions that, when executed by the processor, configure the apparatus to: send, to a user equipment (UE), scheduling information for scheduling a first physical uplink shared channel (PUSCH) transmission and a second PUSCH transmission which are partially overlapped in time domain; and receive the first PUSCH transmission and the second PUSCH transmission performed by the UE using mutually different frequency-domain resources in response to the scheduling information, wherein the first PUSCH transmission and the second PUSCH transmission are from a first antenna panel and a second antenna panel of the UE, respectively.

Example 18 may include the apparatus of Example 17, wherein the frequency-domain resources for the first PUSCH transmission are interlaced with the frequency-domain resources for the second PUSCH transmission.

Example 19 may include the apparatus of Example 18, wherein the scheduling information includes a Frequency Domain Resource Assignment (FDRA), and frequency-domain resources indicated by the FDRA are split and interlaced based on an interlace unit for the first and second PUSCH transmissions, and wherein the interlace unit is one of a resource element (RE), a physical resource block (PRB) or multiple PRBs.

Example 20 may include the apparatus of Example 17, wherein the frequency-domain resources for the first PUSCH transmission are separated from the frequency-domain resources for the second PUSCH transmission.

Example 21 may include the apparatus of Example 20, wherein the scheduling information includes one of the following: a Frequency Domain Resource Assignment (FDRA) for the first PUSCH transmission, wherein the frequency-domain resources for the second PUSCH transmission are determined by a frequency offset from the frequency-domain resources for the first PUSCH transmission, the frequency offset including 0 or more resource elements (REs) or physical resource blocks (PRBs), or respective FDRAs for the first and second PUSCH transmissions.

Example 22 may include the apparatus of Example 17, wherein the scheduling information includes a Time Domain Resource Assignment (TDRA) for both of the first and second PUSCH transmissions, or wherein the scheduling information includes respective Time Domain Resource Assignments (TDRAs) for the first and second PUSCH transmissions.

Example 23 may include the apparatus of Example 17, wherein the scheduling information includes one of the following: precoding information common to the first and second PUSCH transmissions, or respective precoding information for the first and second PUSCH transmission, wherein the precoding information includes at least one of sounding reference signal (SRS) resource indicator (SRI), transmission configuration indication (TCI) state, and transmit precoding matrix indicator (TPMI).

Example 24 may include the apparatus of Example 17, wherein the first PUSCH transmission and the second PUSCH transmission have the same number of layers; and/or wherein the first PUSCH transmission and the second PUSCH transmission have the same antenna port configuration.

Example 25 may include the apparatus of Example 24, wherein the scheduling information includes PTRS-DMRS association information common to the first and second PUSCH transmissions, and/or wherein the first and second PUSCH transmissions share the same one-port PTRS.

Example 26 may include the apparatus of Example 17, wherein at least one of the following is supported: a transport block (TB) is jointly encoded for and transmitted by the first and second PUSCH transmissions; or a TB is transmitted by the first and second PUSCH transmissions in repetition; or different TBs are transmitted by the first and second PUSCH transmission.

Example 27 may include the apparatus of Example 17, wherein the scheduling information includes Modulation and coding scheme (MSC) and/or new data indicator (NDI) and/or Redundancy Version (RV) common to the first and second PUSCH transmissions; or

wherein the scheduling information includes respective MSCs and/or NDIs and/or RVs for the first and second PUSCH transmissions.

Example 28 may include the apparatus of Example 17, wherein the scheduling information includes uplink power control information such that the same power spectral density (PSD) is ensured for both of the first and second PUSCH transmissions, or the first and second PUSCH transmissions have their own different transmit power.

Example 29 may include a method comprising: receiving, from a base station, scheduling information for scheduling a first physical uplink shared channel (PUSCH) transmission and a second PUSCH transmission which are at least partially overlapped in time domain; and in response to the scheduling information, performing the first PUSCH transmission through a first antenna panel and the second PUSCH transmission through a second antenna panel by using mutually different frequency-domain resources.

Example 30 may include a method comprising: sending, to a user equipment (UE), scheduling information for scheduling a first physical uplink shared channel (PUSCH) transmission and a second PUSCH transmission which are partially overlapped in time domain; and receiving the first PUSCH transmission and the second PUSCH transmission performed by the UE using mutually different frequency-domain resources in response to the scheduling information, wherein the first PUSCH transmission and the second PUSCH transmission are from a first antenna panel and a second antenna panel of the UE, respectively.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. An apparatus of a user equipment (UE), the apparatus comprising:
a processor; and
a memory storing instructions that, when executed by the processor, configure the apparatus to:
receive, from a base station, scheduling information for scheduling a first physical uplink shared channel (PUSCH) transmission and a second PUSCH transmission which are at least partially overlapped in time domain; and
in response to the scheduling information, perform the first PUSCH transmission through a first antenna panel and the second PUSCH transmission through a second antenna panel by using mutually different frequency-domain resources.

2. The apparatus of claim 1, wherein the frequency-domain resources for the first PUSCH transmission are interlaced with the frequency-domain resources for the second PUSCH transmission.

3. The apparatus of claim 2, wherein the scheduling information includes a Frequency Domain Resource Assignment (FDRA), and frequency-domain resources indicated by the FDRA are split and interlaced based on an interlace unit for the first and second PUSCH transmissions, and wherein the interlace unit is one of a resource element (RE), a physical resource block (PRB) or multiple PRBs.

4. The apparatus of claim 1, wherein the frequency-domain resources for the first PUSCH transmission are separated from the frequency-domain resources for the second PUSCH transmission.

5. The apparatus of claim 4, wherein the scheduling information includes one of the following:
a Frequency Domain Resource Assignment (FDRA) for the first PUSCH transmission, wherein the frequency-domain resources for the second PUSCH transmission are determined by a frequency offset from the frequency-domain resources for the first PUSCH transmission, the frequency offset including 0 or more resource elements (REs) or physical resource blocks (PRBs), or
respective FDRAs for the first and second PUSCH transmissions.

6. The apparatus of claim 1, wherein the same resource allocation type is configured for the first and second PUSCH transmissions.

7. The apparatus of claim 1, wherein the scheduling information includes a Time Domain Resource Assignment (TDRA) for both of the first and second PUSCH transmissions.

8. The apparatus of claim 1, wherein the scheduling information includes respective Time Domain Resource Assignments (TDRAs) for the first and second PUSCH transmissions.

9. The apparatus of claim 8, wherein the TDRAs refer to the same TDRA table, or wherein the TDRAs refer to different TDRA tables.

10. The apparatus of claim 1, wherein the scheduling information includes one of the following:
precoding information common to the first and second PUSCH transmissions, or
respective precoding information for the first and second PUSCH transmission,
wherein the precoding information includes at least one of sounding reference signal (SRS) resource indicator (SRI), transmission configuration indication (TCI) state, and transmit precoding matrix indicator (TPMI).

11. The apparatus of claim 1, wherein the first PUSCH transmission and the second PUSCH transmission have the same number of layers; and/or
wherein the first PUSCH transmission and the second PUSCH transmission have the same antenna port configuration.

12. The apparatus of claim 11, wherein the scheduling information includes PTRS-DMRS association information common to the first and second PUSCH transmissions, and/or
wherein the first and second PUSCH transmissions share the same one-port PTRS.

13. The apparatus of claim 1, wherein at least one of the following is supported:
a transport block (TB) is jointly encoded for and transmitted by the first and second PUSCH transmissions; or
a TB is transmitted by the first and second PUSCH transmissions in repetition; or
different TBs are transmitted by the first and second PUSCH transmission.

14. The apparatus of claim 1, wherein the scheduling information includes Modulation and coding scheme (MSC) and/or new data indicator (NDI) and/or Redundancy Version (RV) common to the first and second PUSCH transmissions; or
wherein the scheduling information includes respective MSCs and/or NDIs and/or RVs for the first and second PUSCH transmissions.

15. The apparatus of claim 1, wherein the scheduling information includes uplink power control information such that the same power spectral density (PSD) is ensured for both of the first and second PUSCH transmissions, or the first and second PUSCH transmissions have their own different transmit power.

16. The apparatus of claim 15, wherein the transmit power of each of the first and second PUSCH transmissions is scaled by the same factor or based on priority.

17. An apparatus of a base station, the apparatus comprising:
a processor; and
a memory storing instructions that, when executed by the processor, configure the apparatus to:
send, to a user equipment (UE), scheduling information for scheduling a first physical uplink shared channel (PUSCH) transmission and a second PUSCH transmission which are partially overlapped in time domain; and
receive the first PUSCH transmission and the second PUSCH transmission performed by the UE using mutually different frequency-domain resources in response to the scheduling information, wherein the first PUSCH transmission and the second PUSCH transmission are from a first antenna panel and a second antenna panel of the UE, respectively.

18. The apparatus of claim 17, wherein the frequency-domain resources for the first PUSCH transmission are interlaced with the frequency-domain resources for the second PUSCH transmission.

19. The apparatus of claim 18, wherein the scheduling information includes a Frequency Domain Resource Assignment (FDRA), and frequency-domain resources indicated by the FDRA are split and interlaced based on an interlace unit for the first and second PUSCH transmissions, and wherein the interlace unit is one of a resource element (RE), a physical resource block (PRB) or multiple PRBs.

20. The apparatus of claim 17, wherein the frequency-domain resources for the first PUSCH transmission are separated from the frequency-domain resources for the second PUSCH transmission.

21-30. (canceled)
